(19) United States
(12) Patent Application Publication
(10) Pub. No.: US 2005/0170056 A1
(43) Pub. Date: Aug. 4, 2005

(54) Method for the slicing of food products

(75) Inventor: Guenther Weber, Neubrandenburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Weber Maschinenbau GmbH & Co. KG, Breidenbach (DE)

(21) Appl. No.: 11/040,344

(22) Filed: Jan. 20, 2005

Related U.S. Application Data
(63) Continuation-in-part of application No. 09/958,512, filed on Mar. 18, 2002, now abandoned.

(30) Foreign Application Priority Data
Apr. 8, 1999 (DE) 19915961.4

(51) Int. Cl. A23L 1/00

(52) U.S. Cl. 426/518

(57) ABSTRACT

The invention relates to a method for classifying portions in which the cut surfaces of the slices to be removed from a product are detected by an opto-electronic unit, and the images of cut surfaces are evaluated on the basis of the proportional presence of the components in the product and the relative values of the components. Slices of the product which have identical inner structures within predeterminable tolerance limits can be combined to form portions of a defined grade.

### RELATED APPLICATIONS

This is a continuation-in-part application of copending application Ser. No. 09/958,512 filed Mar. 18, 2002 for Method For The Slicing Of Food Products.

### BACKGROUND OF THE INVENTION

The invention relates to a method for the slicing of food products having a non-uniform inner structure, such as sausage, ham and the like, in which the products are cut into slices and shingled portions or stack portions are formed and transported away from the slicing region with a conveyor system. The cut surfaces of each of the slices to be separated from the product are detected by an opto-electronic unit, and an evaluation of the cut surfaces or of the signals representing the cut surfaces takes place.

When slicing food products, it is not only important to achieve portions which are of as constant a weight as possible and which consist of shingled or stacked slices, but it is frequently also desired to ensure that the inner structure of the product slices within the individual portions, for example the fat portion and the lean portion in sausage slices or ham slices, is as equal as possible. Portions with an inner structure of the same kind do not just produce an optimum appearance, but also result in defined values; that is, classifications are possible which also allow different pricings and enable a differentiation between portions of a higher value and portions of a lower value.

This so-called grading of portions has previously been carried out by a manual sorting of portions produced in the slicing of products, with this grading or classification only being able to be carried out very roughly by persons due to the speed of the portion formation and due to the fact that, in a finished stacked portion, only the topmost slice is visible and, with a shingled portion, only regions of the slices are visible. The required labor effort is moreover unwanted and uneconomical.

EP-A-O 449 512 discloses a method for evaluating surfaces of a product being cut in which image data of the product generated by a camera is compared to an intensity threshold.

### SUMMARY OF THE INVENTION

It is an object of the invention to provide a method for the slicing of food products in a manner so that an automatic classification or an automatic grading can be achieved and with it being ensured, even at high cutting speeds, that the deviations in the inner structure of the individual slices of a portion always lie in a defined, pre-settable tolerance range and that thus a very differentiated classification can be ensured.

This object is satisfied in accordance with the invention by providing weighting factors for the different components of the product and collecting product slices having the same inner structure within pre-settable tolerance limits together in portions of a specific grade, or by valuing the product, or a stack of product slices, for example, with the weighting factors.

Thus, the present invention involves determining the proportions of the different components in the product (their proportional presence). The proportional presence of a given component is then multiplied with a factor (other than its proportional presence) to establish a value for the component.

When a food product, say, meat or sausage, is sliced, the cross-section of the slices will have a variety of product components, such as lean meat, fat, blood spots and the like, which become visible at the cut face of the product, as well as the two faces of each slice. The relative proportions of the components visible at the cut face are typically determined by optically scanning the cut face. The various components in the product are then multiplied by the weighting factor to give a value based on their characteristics, desirability by consumers, availability, etc. This weighting factor and the value of the slice are typically independent of the proportional presence of the components visible at the cut face.

Thus, in the case of a product having three components, such as lean meat, fat and blood spots, one of the components, in this case lean meat, has the highest value, and another component the lowest value. In accordance with the invention, the proportion of each component in the product (which, together, add up to 100%) is multiplied by a weighting factor indicative of the valuation of the component to thereby establish the relative value of the component. These values are then summed to arrive at a value of the slice being cut. As a result, the value of the slice in question is determined by the values of the respective components in the product slice so that, when the product has relatively more low value components, the slice will have a value that is less than the value of a slice which has relatively more high value components.

The present invention therefore permits one to accurately value food product slices. Even though modern slicing machines operate at very high speeds, often at a rate of several hundred slices per minute and more, the product slices can be valued as they are sliced. This permits one to form product slice stacks with slices of a value that is within a predetermined range, to segregate slices of differing valuation ranges into differently valued stacks, etc. By using high-speed opto-electronic scanners on today's high-speed slicing machines, stacks of slices of approximately the same valuation can be reliably and rapidly formed, thereby eliminating the need for slow and inaccurate inspections by individuals.

### DESCRIPTION OF THE PREFERRED EMBODIMENTS

The respective portions of different components relating to the surface are preferably detected with respect to the product inner structure, with the meat portions or the lean portions and the fat portions, for example, being able to be selected as the components.

Since the proportions of different components can also have different effects on the quality or value of the respective product, different tolerance limits are also preferably pre-set for different components in accordance with the invention, and weighting factors can also be taken into account for different components.

The respective slice thickness can also be taken into account in the weighting factors since the slice thickness is changed within a portion in a number of slicing procedures with respect to the achievement of portions of constant weight.

If the individually formed portions are associated with specific grades, then these graded portions formed successively, optionally in an irregular order, can be electronically marked such that the corresponding marking or characterizing can take place in a simple manner in the packaging of the respective portions.

As a rule, portions of at least one specific grade are formed from a certain product, and product slices outside the pre-set tolerance range, or the pre-set tolerance ranges, are sorted out or removed, which can be done by a corresponding control of the conveying means associated with the product formation region or can, for example, take place by pivoting a conveying unit into the stream of formed slices.

When a minimum size of the surface of the respective product slice is not reached, this can also be used as a further sorting criterion for the formed slices.

A conveyor system is preferably associated with the portion forming region provided at the cutting station by means of which its product slices belonging to a specific grade, or part portions formed from these product slices, can alternately be moved between the product forming region and individual parking positions and can be transported away after completion of the respective portion. Appropriate blank cuts can be carried out in order to have sufficient time available for the moving operations in each case, also with fast-running slicing procedures.

Thus, in one embodiment of the invention, the product may have two components, for example lean meat and fat, in a sausage (or in bacon, raw beef, chicken, fish, etc.), or undesirable holes in cheese, which are visible at the cut face of the product. The proportion of the face surface covered by the two components is determined, typically, with an opto-electronic sensor. For example, the cut product face might have a proportion of 90% lean (high value) meat and 10% (low value) fat, which is determined on the basis of the percentages of the cut face area occupied by the respective components. If fat in the product in question is assumed to be half as valuable as lean meat, then the proportional presence of fat is multiplied by a factor of 0.5, while lean meat is multiplied by a factor of 1.0. As a result, the slice is valued by assigning a lower weighting factor to the fat and a higher weighting factor to the lean meat.

In another embodiment of the invention, it might be desired to form stacks of slices from two products each having at least two different components. Blood spots (the “bad” component in one of the two products) might be regarded less valuable than fat (the “bad” component in the other product). In order to take these differences into account when determining a value of the final portion or stack, different weighting factors are used in the manner described above to value the two-product stack of slices.

At times, the value of a product may also be affected by the proportional amount of the low value component(s). For example, it may be desired to slice a product, such as sausage, consisting, for example, of lean meat, fat and blood spots. If blood spots are less desirable than fat, the presence of relatively more blood spots disproportionately lowers the value of the entire product so that, for example, a product with 10% of blood spots and 5% of fat is less desirable than a product with 5% blood spots and 10% fat. Although the low value components take up 15% of both products, the different, overall valuation of the two products is reflected by assigning a relatively lesser value to blood spots than to fat and using correspondingly adjusted weighting factors for these components which not only take into account the lesser value of blood spots and fat, but additionally the further devaluation of the product when the proportion of the relatively lesser value component (blood spots) increases relative to the higher value component (fat).

The weighting factor by which the proportional presence of the components is multiplied need not be linear. For example, a slice of ham having 5% of fat might be regarded more than twice as valuable than a slice of ham having 10% of fat. To properly value such a product in accordance with the invention, the fat component of the ham slice is multiplied by a weighting factor which nonlinearly decreases (or increases, as the case may be) so that, in this example, an increase of only 5% of fat in the slice of ham lowers the value of the slice by 50%.

Thus, in accordance with the invention, the proportional presence of the different product components in the cut slices (or the cut face of the product) is first determined and then multiplied by factors which reflect the values of the components, and which are normally other than the measured proportions of the components in the product slices, to value the slices. In any event, however, the weighting factors cannot be all the same; otherwise all components would be treated as having the same value, and there would be no weighting. Thus, at least two of the components must have different weighting factors. Knowing the value of the slices based on their objective valuation is useful in classifying the slices for a variety of purposes.

1. A method for slicing and valuing a product having a plurality of different product components of differing values comprising
cutting the product into slices to provide cut faces where the components are visible,
opto-electronically viewing the cut faces and determining relative proportions of the components visible at the faces,
assigning a weighting factor to each component which reflects the value of the component,
determining a value of each slice on the basis of the proportion of the components visible at a face of the slice and the weighting factors of the respective components, and
collecting a plurality of slices having values which are within a predefined range in a unit of slices.

2. A method in accordance with claim 1 wherein the different components comprise lean meat and fat.

3. A method in accordance with claim 1 wherein viewing includes detecting color distributions in the cut faces.

4. A method in accordance with claim 1 wherein weighting factors also reflect a thickness of the respective slices.

5. A method in accordance with claim 1 including moving the slices with a conveyor away from the product for forming portions of a plurality of slices which have a value within a pre-defined range.

6. A method according to claim 5 including moving slices of differing valuations to different positions and forming stacks of slices of approximately like value at the respective positions.

7. A method for the high-speed production of portions of a plurality of slices of a product having at least first and second components of differing value, the method comprising
cutting the product to form product slices and expose a face of the product,
viewing the product face and determining relative proportions of the at least two components visible in the product face,
establishing a weighting factor for each component which reflects a valuation of the component, and
establishing a value for the slices by multiplying a proportional presence of each component in the product face with the weighting factor.

8. A method for the high-speed production of portions of a plurality of slices of a product having at least first and second components of differing value, the method comprising
cutting the product to form product slices and expose a face of the product,
determining relative proportions of the at least two components present at the product face, and
valuing the slices by multiplying a proportional presence of each component in the product face with a factor, the weighting factors of at least two components being different from each other.
